(19) United States
(12) Patent Application Publication
(10) Pub. No.: US 2014/0122247 A1
(43) Pub. Date: May 1, 2014

(54) METHOD AND SYSTEM FOR ORDERING PRODUCTS

(71) Applicants: Katie Harvey, London (GB); Yuval Moss, London (GB)

(72) Inventors: Katie Harvey, London (GB); Yuval Moss, London (GB)

(21) Appl. No.: 14/126,312

(22) PCT Filed: Jun. 13, 2012
(86) PCT No.: PCT/GB2012/051333

§ 371 Date: Dec. 13, 2013

(30) Foreign Application Priority Data
Jun. 13, 2011 (GB) 1109885.2

(51) Int. Cl. G06Q 30/06; G06Q 30/02

(52) U.S. Cl. CPC G06Q 30/0635; G06Q 30/0269; G06Q 30/0637
USPC 705/14.66; 705/26.81; 705/26.82

(57) ABSTRACT

The present invention relates to a system for product ordering in a communications network (108) including a central server (100) for receiving an order request for a product from a first device (102), the order request associated with a particular user, for selecting a vendor from a plurality of vendors using information associated with the particular user, and for interfacing with a server (105) associated with the selected vendor to transmit a vendor request corresponding to the order request to add the product to a virtual shopping cart of an account of the user at the vendor.

### FIELD OF INVENTION

The present invention is in the field of product ordering. In particular, but not exclusively, the present invention relates to a method and system for ordering products in a communications network.

### BACKGROUND

Traditionally, if a consumer saw an advertisement for a product, such as a Fast Moving Consumer Good (FMCG), that they wished to obtain, the consumer had two options: physically visiting a store, such as a supermarket or pharmacy, to purchase the product or adding the product to a shopping list in order to remember to buy it at a later stage (for example, as part of a weekly shop).

In the present day the consumer also has a third option: purchasing the product from an online store. When a consumer sees an advertisement for a product, they can take the following steps (in one order or another) leading to acquisition of the desired product: (1) launch the website of their preferred vendor on a user device (e.g. laptop, mobile phone); (2) use the vendor's search facility to locate a list of items similar to the one in question (e.g. a search for Heinz Baked Beans™ will return multiple results based on pack size, flavour variants etc); (3) look through the search results and identify the single desired item; (4) select desired item; (5) register on vendor website (for first time user) or enter log-in details (for returning customer); and (6) add the item to their virtual shopping cart.

This option is, however, inefficient and laborious: the consumer is required to interact with the vendor to acquire the product. This requirement to “interact” with the vendor disrupts the consumer's current activity and may lead to lower direct uptake of the product via a product advertisement.

What is desired is a system for enabling a consumer to add a product directly into their shopping cart at their preferred online vendor from an advertisement or display for the product. What is also desired is a system that is more efficient than existing prior art.

It is an object of the present invention to provide a system for ordering products which overcomes the disadvantages of the prior art, or at least provides a useful alternative.

### SUMMARY OF INVENTION

According to a first aspect of the invention there is provided a system for product ordering in a communications network, including: a central server configured to receive an order request for a product from a first device, the order request associated with a particular user, to select a vendor from a plurality of vendors using information associated with the particular user, and to interface with a server associated with the selected vendor to transmit a vendor request corresponding to the order request to add the product to a virtual shopping cart of an account of the user at the vendor.

According to another aspect of the invention there is provided a central server for managing product ordering in a communications network, including: a processor configured for receiving an order request associated with a particular user for a product from one of a plurality of devices through a network interface, extracting information associated with the particular user from a database stored in a memory, using the information to select a preferred vendor from a plurality of vendors, and transmitting a vendor request, corresponding to the order request, through a network interface to a vendor server associated with the preferred vendor to add the product to a virtual shopping cart of an account of the user at the vendor;

a memory configured for storing a database containing user information; and
a network interface configured for communicating with a plurality of devices and a plurality of vendor servers.

According to another aspect of the invention there is provided a computer-implemented method for managing product ordering in a communications network, including:

a) a server receiving an order request for a product, wherein the order request is associated with a particular user;
b) the server selecting a specific vendor from a plurality of vendors using information associated with the particular user; and
c) the server transmitting a vendor request to a server associated with the selected vendor to add the product to the virtual shopping cart of an account of the user at the vendor.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a system in accordance with an embodiment of the invention;

FIG. 2: shows a method in accordance with an embodiment of the invention;

FIG. 3: shows a hardware implementation of the central server in accordance with an embodiment of the invention;

FIG. 4: shows the Ad2Basket system in accordance with an embodiment of the invention;

FIG. 5: shows the Ad2Basket method in accordance with an embodiment of the invention;

FIG. 6: shows a screenshot of an advertisement displayed in accordance with an embodiment of the invention;

FIG. 7: shows a screenshot of a vendor selection stage in accordance with an embodiment of the invention; and

FIG. 8: shows a screenshot of a user authorisation information input stage in accordance with an embodiment of the invention.

### DETAILED DESCRIPTION OF PREFERRED EMBODIMENTS

The present invention provides a method and system for ordering products in a communications network.

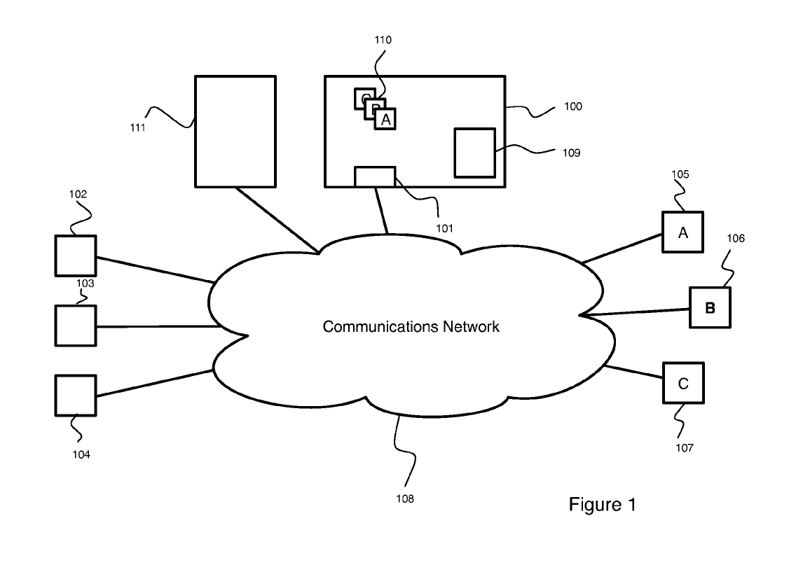

In FIG. 1, a system for ordering products is shown. The system includes a central server 100. The central system 100 includes a communications network interface 101 for communicating with a plurality of devices 102, 103, 104 and a plurality of vendor servers 105, 106, 107 within a communications network 108. The devices may be user devices such as mobile devices, such as cellular mobile telephones or tablet computers, internet-enabled televisions, or computing devices, such as laptop or desktop computers.

The devices may include a user interface to interact with users. In one embodiment, the devices include electronic display devices, such as a public advertising panel. The panel may include a touch-screen to facilitate interaction with users.

The communications network 108 may include the Internet, cellular telecommunications systems, local/wide area network, wireless networks, short-range wireless networks, or a combination of networks.

The central server 100 may include a database 109, such as a secure database, for storing user account information. The information may include the preferred vendor for a user, information to provide user authorisation to the vendor, and/or location information of the user.

The central server 100 may include a plurality of interface modules 110 for interfacing with the plurality of vendor servers 105, 106, 107.

The system may include an advertising server 111 for delivering advertisements for products to the devices 102, 103, 104. The central server 100 and the advertising server 111 may be combined into a single entity.

The advertisements may include functionality to enable the devices 102, 103, 104 to display an advertisement for the product and to drive a response from the user to order the product (such as a “purchase button”).

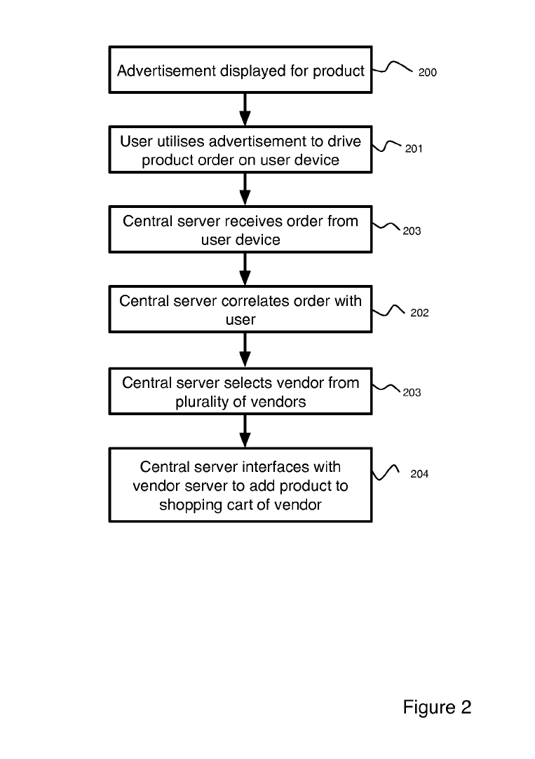

With reference to FIG. 2, a method for ordering products will be described.

In step 200, an advertisement for a product may be displayed to a user. In one embodiment the advertisement is any visual display of the product.

The advertisement may be delivered to a user device 102, 103, 104 by the advertising server 111. Alternatively, the advertisement may be delivered to a second device such as an electronic display device. In one embodiment, the advertisement is a printed advertisement such as a billboard or magazine advertisement.

In one embodiment, the advertisement is displayed in conjunction with a video stream. The video stream may be an Internet-based direct or multicast stream, such as iPlayer™ or Youtube™, or a terrestrial, satellite, or cable broadcast or direct feed. For example, the advertisement may be displayed as an advertisement during a video stream on an Internet enabled television or on an Internet-capable computing device, or as a separate visual display next to or overlaid (such as a pop-up) on the video stream. In one embodiment, the advertisement is a product placement within a programme, such as a television programme.

The advertising server 111 may deliver the advertisements in response to a request from the user device 102, 103, 104, such as an HTTP request driven from a URL. The URLs may exist within third party web pages that have been delivered to the user device 102, 103, 104 by third party web servers.

In step 201, the user may utilise the advertisement to initiate an order request for the product to the central server 100 using the user's user device 102, 103, 104. Where the advertisement was delivered to the user device 102, 103, 104 by the advertising server 111, the advertisement may include functionality to receive an action from the user to initiate the order request such as a “purchase button” and a script to transmit a request for the product, upon the action by the user, to the central server 100.

Where the user device 102, 103, 104 is an Internet TV, the user may utilise a remote controller or remote keyboard to initiate the order request. Other television interfaces may also be utilised to initiate the order request such as voice activated commands or hand movements.

Where the advertisement is displayed on a second device, the user device 102, 103, 104 may interact with the second device (such as by Bluetooth, wireless, IR, or other short-range communication, or using the Internet and/or GPS) to receive information about the product advertisement to provide functionality to transmit a request for the product to the central server 100. Alternatively, the user may interact directly with the second device through a user interface on the second device.

Where the advertisement is on printed matter, the user device 102, 103, 104 may visually receive information about the product from the printed matter (for example, by QR-code or barcode) to provide functionality to transmit a request for the product to the central server 100.

In one embodiment, the action required by the user to initiate the order request is a single action. The single action may also drive interaction of the user device with the second device, or receive information about the product from the printed matter.

In step 202, the central server 100 receives the order request from the user device 102, 103, 104. The order request may be associated with the user. For example, the order request may include an identifier of the user.

Possible methods for associating the order request with the user include use of a cookie stored on the user device 102, 103, 104, the use of a session ID by the server 100, use of a social network API such as Facebook Connect, user details entered through a user interface on the user device, and/or biometric information provided through a biometric input device.

In step 203, the central server 100 may correlate the order request with an account for the user. The correlation may use an identifier of the user received in the order request. User account information may be extracted from a database 109 at the central server 100.

In step 204, the central server 100 selects a vendor from a plurality of vendors using information associated with the user. The information may be extracted from the user account information and may include the last vendor specified by the user during use of the system or it may include the user's specified preferred vendor. Alternatively, the central server 100 transmits a list of vendors to the user device 102, 103, 104 for selection by the user. The list of vendors may be preselected from the plurality of vendors by the central server 100 based on product availability or the geographical location of the user or user device.

In step 205, the central server 100 may interface with a vendor system (such as a vendor server 105, 106, 107) to transmit a vendor request, directly corresponding to the order request, to add the product to the virtual shopping cart of an account of the user at the vendor. The central server 100 may extract an interface module 110 corresponding to the vendor system to interface with the vendor system. The central server 100 may utilise authorisation information for the account of the user at the vendor to add the product to the virtual shopping cart. The authorisation information may be extracted from the user account information in the database 109 of central server 100, or it may be requested from the user.

The interface modules may be developed using development tools and languages (such as .net, Java, PHP, or Ruby) which include methods and libraries for interacting with web sites as users do. The central server 100 may utilise these methods within the interface modules to emulate a user.

Alternatively, some vendors may provide an API (Application Programming Interface), in which an interface module may be constructed to utilise the API of a vendor.

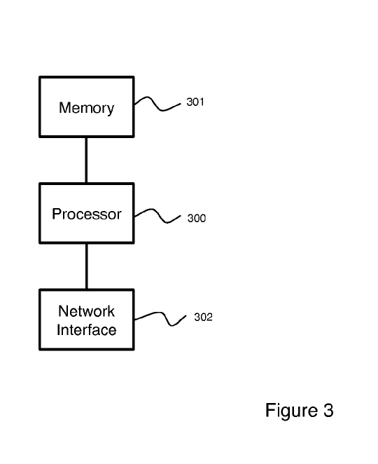

Referring to FIG. 3, an exemplary hardware implementation of the central server 100 will be described.

A processor 300, memory 301, and network interface 302 are shown. The processor 300 is connected to the memory 301 and the network interface 302.

The processor 300 is configured for receiving requests to order products from the plurality of devices through the network interface 302. The processor 300 is further configured to extract user information associated with the order request from a database 109 stored in the memory 301. The processor 300 is further configured to use the order request and the user information to select a vendor. The processor 300 is further configured to connect to a vendor server 105, 106, 107 through the network interface 302 and to authorise a user using the user information. The processor 300 is further configured to transmit a request to the vendor server 105, 106, 107, the request being to add the product of the order request to the virtual shopping cart of the user at the vendor.

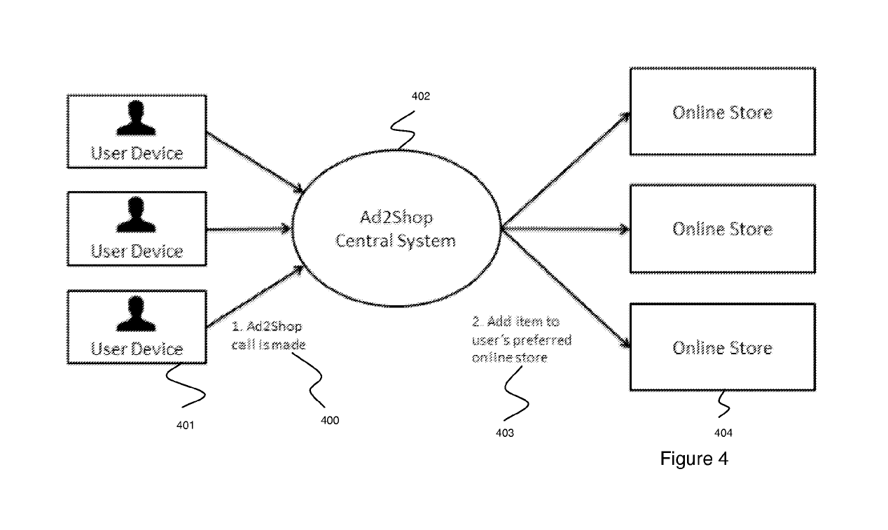

An embodiment of the invention will now be described with reference to FIGS. 4 to 8. This embodiment will be referred to as Ad2Basket.

Referring to FIG. 4, when a product is added to the Ad2Basket service, a dedicated link (URL) per product will be provided. The dedicated link, when actuated, will initiate the Ad2Basket process for a user. When a user clicks/follows the link in step 400 on a user device 401, the Ad2Basket Central System 402 receives the message and initiates the process to add the product in step 403 to the user's preferred online vendor 404. Ad2Basket will interact with the user to complete the process. Once the process is complete, the Central System will add the product to the online shop.

### User Device 401

Ad2Basket can be triggered from any Internet enabled device 401.

This includes a user's personal device 401—i.e. smart phone, laptop, tablet computer or internet enabled television.

The device 401 does not need to be owned by the user, for example a computer in a library, university or Internet café. If information regarding the user is required, he will be prompted for it.

In addition, more and more people are exposed to public devices which display adverts. For example, when walking up or down the escalator on the London underground, people are frequently surrounded by screens which display advertisements. In the future, user may be able to interact or respond to these public devices. When users can interface or respond to these devices, Ad2Basket can be utilised to provide users with the ability to order products. To identify users, Ad2Basket may use smart cards (e.g. oyster cards), credit cards, transmissions from mobile phone, smart driving licence or biometric authentication such as finger print, retina scan or face recognition.

The Ad2Basket link can be placed on a website, or delivered to the user via a communication (for example, online display ad within a website, Twitter™ message, email, Facebook™ message, blogs, text message, or QR codes (for offline media)).

### Online Vendor 404

Ad2Basket facilitates users clicking on an ad (or a link) and adding the featured product directly to the shopping cart of his preferred online vendor 404 where that product/brand is sold. To support this functionality (in this embodiment of the invention), the preferred online vendor 404 must provide a web-based ordering system which utilises the shopping cart concept.

### Ad2Basket Central System 402

The Central System 402 includes the following features:

### 1. Integration to Multiple Online Shops

To be able to connect to, interact with and add products to the shopping carts of multiple online vendor systems 404 (such as Sainsburys, Tesco, Asda, Waitrose, Lloyds Pharmacy, and Boots online), the Central System 402 utilises dedicated code (or plug-ins) for each online shop 404. The plug-in specifies how to interact with the online shop 404 and how to add products to it.

### 2. User Interface

Once a user interacts with Ad2Basket through the link, the Central System 402 may collect information from the user in order to complete the process of adding the product to the online shop 404.

Information collected may include:

a. Preferred supermarket/online shop;
b. Identification and authentication information for the preferred shop (e.g. username and password for Sainsbury's online grocery shopping);
c. User delivery address/post code;
d. Number of units to add to the shop; and
e. Selection between different product variants such as flavours and dietary options (e.g. ‘lite’ versus ‘full fat’ cheese).

The information may be collected using pop-up windows within the web browser used by the user.

### 3. Location Based Services

The Central System 402 may be configured to recognise the geographical location from where the user has connected. Based on this location, the Central System 402 may present the user with a refined selection of online shops which deliver to their location.

If the user's current location is not the intended delivery location, then the latter can be entered by them manually.

### 4. Usage Data Collection

The Central System 402 collects and stores information regarding usage of the system.

This information can provide, for example, the brand owners of the products with insight into their consumers' behaviour and the success rates of their advertising campaign.

The information may be provided in the form of reports or dashboards.

Examples of data collected may include:

a. How many times a product has been added to a shop;
b. Which online shop have the products been added to;
c. From where have the products been added—user location (e.g. London);
d. From where have the products been added—Ad2Basket link location (e.g. www.nytimes.com);
e. When have the products been added (time and date);
f. Type of device through which the product was added;
g. Supermarkets to which users would have liked to add a particular product but couldn't (e.g. because the product isn't sold there);
h. Whether the product is eventually purchased; and
i. Whether users keep the product in their shopping cart for repeat purchases.

### 5. Secure Data Storage

If specified by the user, the user's vendor authentication details (e.g. password) can be securely saved by Ad2Basket. This may simplify the user experience and will enable adding a product to a shop with a single click or gesture (e.g. blink, click of fingers, wave of hand depending on the user interface) from the moment the user is presented with the Ad2Basket link. For example, a user sees an ad for Anchor Butter on NYTimes.com and, with a single click, the user can add the product to his shopping cart.

### 6. Ad2Basket Service Portal

Ad2Basket provides brand owners/manufacturers with a single web portal where their Ad2Basket campaigns can be managed (i.e. create new campaigns, modify existing ones) and to enable them to review reports and dashboards. The reports and dashboards will present the data collected from their campaigns (as described in above). This may allow them to learn more about their customers and to modify their existing marketing/advertising methods accordingly.

Ad2Basket provides information which the brand owners didn't have before how many users have reacted to an ad and actually added the product to the shop—as opposed to simply clicking on an ad.

### User Experience

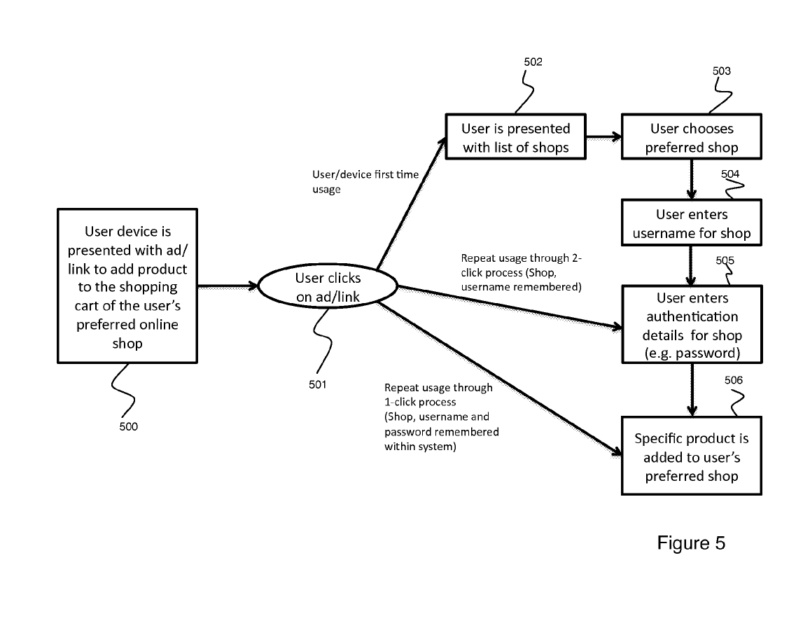

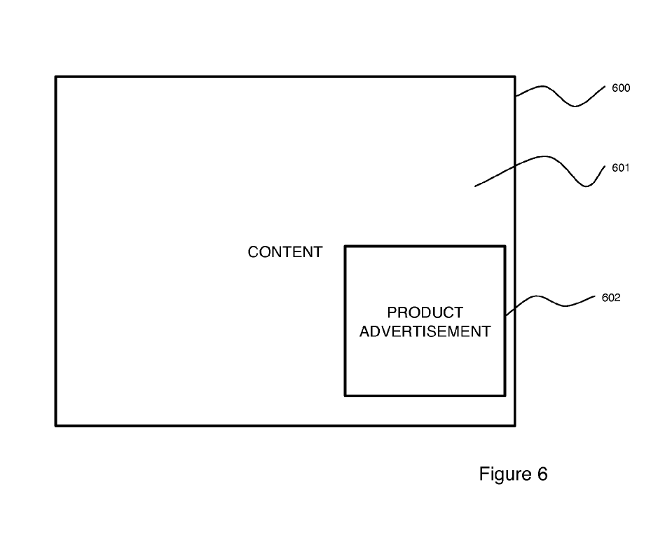

Referring to FIG. 5, when a user is presented 500 with the Ad2Basket link for a specific product, he will have the opportunity to click 501 on the link. FIG. 6 shows an example of a browser page 600 displaying website content 601 and an advertisement 602 incorporating an Ad2Basket link.

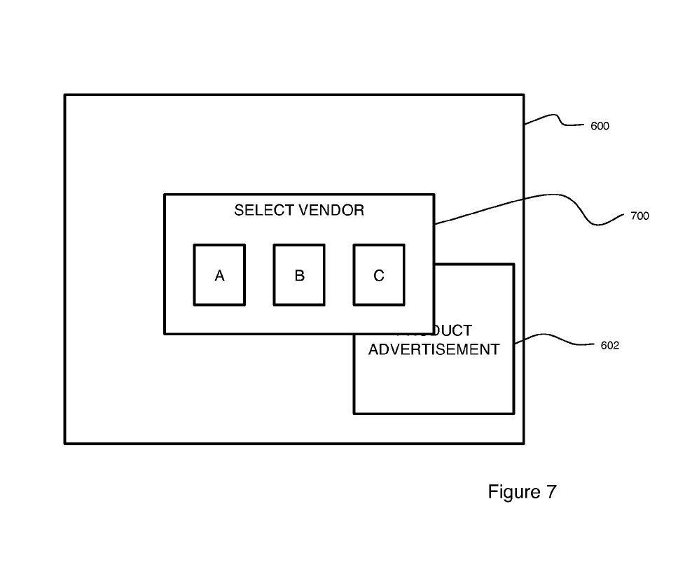

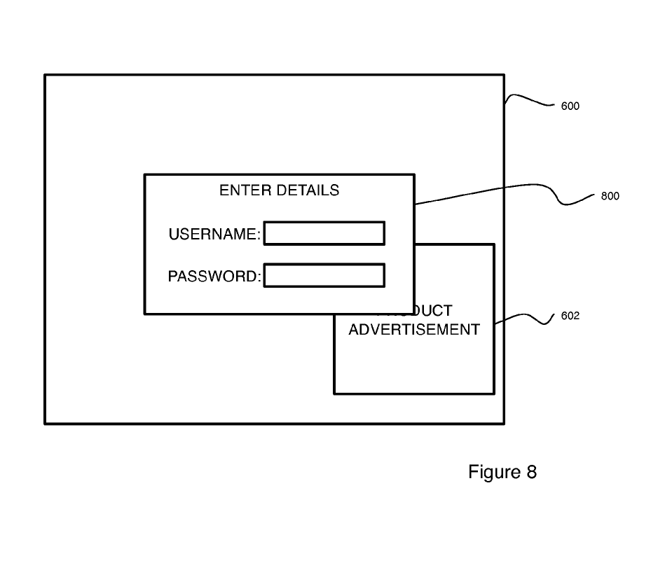

If this is the first time the user uses the Ad2Basket system, the user will be presented 502 with a list of shops and asked by a pop-up window 700 to choose 503 his preferred shop as shown in FIG. 7, and asked to enter his username 504 and the password 505 for the specific online shop (assuming he is already a customer of the online shop, e.g. Tesco.com) within a pop-up window 800 as shown in FIG. 8. Once these details have been entered, the product will automatically be added 506 to the shopping cart of the chosen shop.

If this is a repeat usage of Ad2Basket (i.e. the user has previously used Ad2Basket to add other products to his preferred shopping cart) then the user will only need to enter his password 505 for the online shop. Ad2Basket will remember and automatically fill in/select the user's username and preferred online shop.

In one implementation of the system, the system offers users the option of Ad2Basket remembering their password and therefore enabling a single action experience whereby all the user needs to do is click 501 on the advertisement link and the product will be added 506 to his shopping cart.

Where the user interacts with the Ad2Basket link through a public device such as a public screen, Ad2Basket may be triggered by the user touching the screen and the product will be added to the shopping cart of the user's preferred supermarket. When the user touches the screen, the public device may identify the user using his fingerprint and provide the Ad2Basket Central System with the required information regarding who the user is. In an alternative embodiment, the public device will send a message or trigger a program on the user's personal device (such as a mobile phone) where the user can click and add the product to his preferred shop.

After the product has been added successfully, a confirmation message may appear. The confirmation message may give the user options of what to do next.

For example:

a. Close the window and finish;
b. Choose from a selection of other products provided by this brand or its partners;
c. Go to the brand's website; or
d. Go to the brand's social media properties e.g. Facebook™, Twitter™, Youtube™, etc.

In one implementation of the system, Ad2Basket also provides the functionality to offer products related to those chosen by the user. For example, if Tropicana is advertising its ‘Pure Orange Juice’ product it may wish to suggest other products to the user such as ‘Red Grape Juice’.

In another implementation of the system, Ad2Basket may provide the functionality to pass discounts or deals relating to an advertised voucher through to the shopping cart of the vendor. For example, the advertisement for the product may specify “buy 3 for the price of 2” or “50 percent off second product”. Ad2Basket may feed through a voucher code associated with the advertisement to the vendor to enable the vendor to recoup the cost of the voucher from the corresponding brand owner.

It will be appreciated that the present invention may be implemented as software executing on computer hardware or within hardware itself.

A potential advantage of some embodiments of the present invention is that the use of a central server sitting between the infrastructure of the vendors and the user devices enables user devices to place orders for products without being requiring to interface with the infrastructure of the vendors. Consequently, this lack of interfacing leads to reduction in data transmitted to the user devices over the communications network, reduction in messages transmitted to and from the user devices, and a simpler user interface platform at the user device. Therefore, user devices with simpler interfaces/less functionality and/or user devices connected to the communications network over low bandwidth or high latency connections can conduct transactions to order products using the vendor infrastructure.

A further potential advantage of some embodiments of the present invention is that the use of the central server as a layer between the user devices and the vendor infrastructure means that there is a insulating layer of security between the user devices and the vendor infrastructure because orders are confirmed at a later time by the user directly through the vendor infrastructure. This means that the user devices themselves have a lower security requirement, and the connection between the user devices and the central server can operate at a lower security level. Therefore, the user device hardware can be simpler and the communications connection can utilise a broader (and potentially less secure) range of communications technologies.

A further potential advantage of some embodiments of the present invention is that the use of the central server means that vendor infrastructure does not require replacement or upgrade, and thus legacy vendor infrastructures can support new user devices; furthermore, as the central server coordinates communications with a plurality of vendor servers, user devices only need to be configured to interface with the central server resulting in a reduction in user device modifications and/or user device hardware requirements.

A further potential advantage of some embodiments of the present invention is that users can add products to their online shopping cart quickly and easily without disrupting their natural browsing experience.

A further potential advantage of some embodiments of the present invention is that the system can drive online impulse purchase, turn advertising into e-commerce and online marketing into a direct sales channel, bring a product's point of sale to users as part of their natural browsing and social networking experience, and enable FMCG brand owners to advertise at the point of sale without being dependent upon retailers.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A system for product ordering in a communications network, including: a central server configured to receive an order request for a product from a first device, the order request associated with a particular user, to select a vendor from a plurality of vendors using information associated with the particular user, and to interface with a server associated with the selected vendor to transmit a vendor request corresponding to the order request to add the product to a virtual shopping cart of an account of the user at the vendor.

2. A system as claimed in claim 1, further including an advertisement server configured to receive a request for an advertisement for the product from a second device using the communications network, and to deliver the advertisement to the second device using the communications network.

3. A system as claimed in claim 2, wherein the advertisement is an advertisement for display in a web browser.

4. A system as claimed in claim 1 wherein the central server is further configured to determine a set of applicable vendors for the product.

5. (canceled)

6. A system as claimed in claim 4, wherein the central server determines the set of applicable vendors based, at least in part, on which of the plurality of vendors offers the product or the geographical location associated with the user.

7. A system as claimed in claim 4, wherein the central server is further configured to transmit the set of applicable vendors for the product to the first device and to receive a response from the first device to define the selected vendor from the set of applicable vendors.

8. A system as claimed in claim 1, wherein the central server is further configured to receive authorisation information for the account from the first device.

9. (canceled)

10. (canceled)

11. A system as claimed in claim 1, wherein the central server is further configured to use stored authorisation information for the account to interface with the server of the selected vendor.

12. A system as claimed in claim 2, wherein the first and second device are the same device.

13. (canceled)

14. (canceled)

15. (canceled)

16. A system as claimed in claim 1 wherein the order request includes an identifier of the user.

17. A system as claimed in claim 1 wherein the order request is received from the first device.

18. A system as claimed in claim 1 wherein the central server is further configured to extract the information associated with the particular user from a database and the wherein the information associated with the particular user includes the preferred vendor of the particular user.

19. A system as claimed in claim 1 wherein the vendor request includes authorisation information associated with the user and with the selected vendor.

20. A system as claimed in claim 1 wherein the central server is further configured to extract an interface module from a plurality of interface modules to interface with a web server of the selected vendor.

21. (canceled)

22. A system as claimed in claim 1 wherein the system further includes the first device, wherein the first device and the central server are configured to transmit the vendor request to the server of the selected vendor in response to a single action of a user of the first device.

23. A system as claimed in claim 1 wherein the vendor is an entity which conveys order requests from the shopping cart to one or more further vendors for actuating the purchase of the product.

24. A system as claimed in claim 1 wherein the central server is further configured to interface with the server of selected vendor to determine whether the product is eventually purchased by the user.

25. A system as claimed in claim 1 wherein the first device is one or more selected from the set of a mobile device, a smartphone, a computer, a public device, and an Internet enabled television.

26. (canceled)

27. A system as claimed in claim 1 wherein the order request is associated with a specific price for the product, a discount related to the product, or a voucher for the product.

28. (canceled)

29. A computer-implemented method for managing product ordering in a communications network, including:
a) a server receiving an order request for a product, wherein the order request is associated with a particular user;
b) the server selecting a specific vendor from a plurality of vendors using information associated with the particular user; and
c) the server transmitting a vendor request to a server associated with the selected vendor to add the product to the virtual shopping cart of an account of the user at the vendor.

30. (canceled)

31. (canceled)

32. (canceled)

33. (canceled)

34. (canceled)

35. A computer program product carrying a computer program embodied in a computer readable medium adapted to perform the method of claim 20
